(19) United States
(12) Patent Application Publication
(10) Pub. No.: US 2007/0265042 A1
(43) Pub. Date: Nov. 15, 2007

(54) Game program and game apparatus

(75) Inventors: Eiji Akahori, Minato-ku (JP); Shingo Miyata, Minato-ku (JP); Toshiharu Izuno, Kyoto-shi (JP); Takuji Hotta, Kyoto-shi (JP); Kentaro Nishimura, Kyoto-shi (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/797,565

(22) Filed: May 4, 2007

(30) Foreign Application Priority Data
May 9, 2006 (JP) 2006-130775
Apr. 23, 2007 (JP) 2007-112874

(51) Int. Cl. A63F 13/00

(52) U.S. Cl. 463/1

(57) ABSTRACT

Each time a player hits either one of right and left strike surfaces of a conga controller, it is determined whether: the right strike surface has been hit continuously; the left strike surface has been hit continuously; or the right strike surface and the left strike surface have been hit alternately. When the right strike surface has been hit continuously, a character in a game world is caused to move rightward. When the left strike surface has been hit continuously, the character is caused to move leftward. When the right strike surface and the left strike surface have been hit alternately, the character is caused to accelerate. Based on the above, a game program and a game apparatus, which are capable of giving various action instructions to the character of the virtual game world by using continuous inputs by a plurality of switches, can be provided.

### CROSS REFERENCE TO RELATED APPLICATION

The disclosure of Japanese Patent Application No. 2006-130775, filed on May 9, 2006, and Japanese Patent Application No. 2007-112874, filed on Apr. 23, 2007, is incorporated herein by reference.

### BACKGROUND OF THE INVENTION

1. Field of the Invention

The present invention relates to a game program and a game apparatus. The present invention particularly relates to a game program and a game apparatus for controlling an action of an object in a virtual game world by using input means capable of detecting a first operation and a second operation (e.g., input means including a first switch and at least one other switch different from the first switch, or input means capable of detecting a first movement input operation and a second movement input operation).

2. Description of the Background Art

Japanese Laid-Open Patent Publication No. 2005-319040 (hereinafter, referred to as Patent Document 1) discloses a game system in which a player can control an action of a character in a virtual game world displayed on a screen, by using, as operation switches, two strike surfaces provided on a conga controller which are right and left strike surfaces. In this game system, when the player hits a right conga, the player character moves to the right, and when the player hits a left conga, the player character moves to the left. Further, when the player hits the right and left congas at the same time, the player character jumps. In a particular scene, the player character performs an attack action when the player continuously and alternately hits the right and left congas. This allows the player to give, to the character in the virtual game world, action instructions which outnumber the number of switches.

However, the above Patent Document 1 merely describes that when the player hits the right (or left) conga, the player character moves to the right (or left), and when the player continuously and alternately hits the right and left congas, the player character performs an attack action. Patent Document 1 does not disclose how, in the case where these two types of inputs coexist, e.g., in the case where after continuously hitting the left conga, the player continuously and alternately hits the right and left congas, and further hits the right conga continuously, the character is caused to perform an action based on such a series of operations. Moreover, there are merely two moving directions, i.e., right and left, and it is impossible to control a three-dimensional movement.

### SUMMARY OF THE INVENTION

Therefore, an object of the present invention is to solve at least one of the above-described problems and to provide a game program and a game apparatus which are capable of giving various action instructions to a character in a virtual game world by using continuous inputs based on a plurality of types of operations (i.e., a plurality of switch operations or a plurality of movement input operations).

The present invention has the following features to achieve the object mentioned above. Note that reference numerals indicated between parentheses are merely provided to facilitate the understanding of the present invention in relation to the drawings, rather than limiting the scope of the present invention in any way.

A computer-readable storage medium of the present invention stores a game program for controlling an action of an object in a virtual game world by using input means including a first switch (6R) and at least one other switch (6L) different from the first switch. The game program causes a computer (31) to function as display control means (S10, S50), input detection means (S12, S60, S68), first determination means (S20, S22, S24, S26, S62), and action control means (S30, S32, S64, S66, S72 and S74). The display control means displays the object on a screen (2). The input detection means detects an input performed by the input means. The first determination means determines, each time the input detection means detects an input performed by the first switch, whether inputs have been continuously performed by the first switch, or inputs have been alternately performed by the first switch and the at least one other switch. When the first determination means determines (a) that inputs have been continuously performed by the first switch, the action control means causes the object to perform a first action associated with the first switch, and when the first determination means determines (b) that inputs by the first switch and the at least one other switch have been alternately performed, the action control means causes the object to perform a second action different from the first action.

The first determination means may determine, by comparing an input most recently performed with an input performed immediately prior to the most recently performed input, whether inputs have been continuously performed by the first switch, or inputs have been performed by the first switch and the at least one other switch alternately. Alternatively, this determination may be performed based on the most recently performed input and a plurality of inputs performed prior to the most recently performed input (e.g., the most recently performed input, an input immediately preceding the most recently performed input, and an input preceding the most recently performed input by two inputs). In the latter case, for example, a determination that inputs have been continuously performed by the first switch may be provided when inputs by the first switch have been continuously performed three times or more. A determination that inputs by the first switch and the at least one other switch have been alternately performed may be provided when inputs by the first switch and the at least one other switch have been alternately performed twice or more.

Typically, each time the input detection means has detected an input from the input means, a memory may store, as input history information, whether the input detected by the input detection means has been performed by the first switch or the at least one other switch. Thereafter, the input history information may be referred to when the input detection means has detected an input performed by the first switch.

The at least one other switch to be used for controlling the action of the object may be one switch or a plurality of switches.

When the at least one other switch is only one switch (hereinafter, referred to as a second switch), the first determination means determines whether inputs by the first switch have been continuously performed, or inputs have been performed by the first and second switches alternately. For example, when a sequence of performed inputs is as follows: an input by the first switch; and an input by the first switch again, it may be determined that inputs have been performed by the first switch continuously. Further, when a sequence of performed inputs is as follows: an input by the first switch; an input by the second switch; and an input by the first switch, it may be determined that inputs have been performed by the first switch and the at least one other switch alternately. When, in the case where only a most recently performed input and an input performed immediately prior to the most recently performed input are referred to, a sequence of performed inputs is as follows: an input by the second switch; and then an input by the first switch, it may be determined that inputs have been performed by the first and second switches alternately.

When, in the case where the at least one other switch are a plurality of switches, inputs have been performed by the first switch and a particular one of the at least one other switch (e.g., second switch) alternately, the first determination means may determine that inputs have been performed by the first switch and the at least one other switch alternately. In this case, the first determination means may ignore an input from a switch different from the first and second switches (e.g., third switch) when determining whether inputs have been continuously performed by the first switch, or inputs have been performed by the first switch and the at least one other switch alternately. Alternatively, the first determination means may not ignore an input from a switch different from the first and second switches (e.g., third switch) when determining whether inputs have been continuously performed by the first switch, or inputs have been performed by the first switch and the at least one other switch alternately. In the case of ignoring an input from a switch different from the first and second switches (e.g., third switch), the first determination means may determine that inputs by the first switch have been continuously performed when a sequence of performed inputs is, for example, as follows: an input by the first switch; an input by the third switch; and an input by the first switch (input pattern A). Also, when a sequence of performed inputs is, for example, as follows: an input by the first switch; an input by the second switch; an input by the third switch; and an input by the first switch (input pattern B), the first determination means may determine that inputs have been performed by the first switch and the at least one other switch alternately. In the case of not ignoring an input from a switch different from the first and second switches (e.g., third switch), the first determination means does not determine that inputs have been continuously performed by the first switch when inputs according to the above input pattern A have been performed. Also, when inputs according to the above input pattern B have been performed, the first determination means does not determine that inputs have been performed by the first switch and the at least one other switch alternately.

In the case where the at least one other switch are a plurality of switches, the first determination means may determine that inputs by the first switch and the at least one other switch have been alternately performed when inputs by the first switch and any arbitrary one of the at least one other switch (an arbitrary switch different from the first switch) have been alternately performed. For example, the first determination means may determine that inputs have been performed by the first switch and the at least one other switch alternately when a sequence of performed inputs is whichever of the following: an input by the first switch, an input by the second switch, and an input by the first switch; and an input by the first switch, an input by the third switch, and an input by the first switch.

Here, each time the input detection means detects an input performed by the first switch, the first determination means determines whether inputs have been continuously performed by the first switch, or inputs have been performed by the first switch and the at least one other switch alternately, and then the character is caused to perform the first or second action accordingly. To be specific, when a series of performed inputs is, for example, as follows: an input by the first switch (a); an input by the first switch (b); an input by the at least one other switch (c); and an input by the first switch (d), the first determination means determines at (b) that continuous inputs have been performed, and then the character is caused to perform the first action accordingly. Further, the first determination means determines at (d) that alternate inputs have been performed, and then the character is caused to perform the second action accordingly. However, in a particular situation, the character may not be caused to perform the first action or the second action, for example, when an input has been performed by the first switch for the first time.

Here, the first and second actions may be moving actions, or other actions (e.g., attack actions or jump actions)

The input means includes at least a second switch as the at least one other switch. The first determination means determines, each time the input detection means detects an input performed by the first switch, whether inputs by the first switch have been continuously performed, or inputs by the first switch and the second switch have been alternately performed. When the first determination means determines (a) that inputs by the first switch have been continuously performed, the action control means may cause the object to perform the first action, and when the first determination means determines (b) that inputs by the first switch and the second switch have been alternately performed, the action control means may cause the object to perform the second action.

The game program further causes the computer to function as second determination means (S70) which determines, each time the input detection means detects an input performed by the second switch, whether inputs by the second switch have been continuously performed, or inputs by the first switch and the second switch have been alternately performed. When the second determination means determines (c) that inputs by the second switch have been continuously performed, the action control means may cause the object to perform a third action associated with the second switch, and when the second determination means determines (d) that inputs by the first switch and the second switch have been alternately performed, the action control means may cause the object to perform the second action.

Here, each time the input detection means detects an input performed by the first switch, the first determination means determines whether inputs have been continuously performed by the first switch, or inputs have been performed by the first switch and the second switch alternately. Also, each time the input detection means detects an input performed by the second switch, the second determination means determines whether inputs have been continuously performed by the second switch, or inputs have been performed by the second switch and the first switch alternately. Then, the object is caused to perform the first, second or third action accordingly. To be specific, when a series of performed inputs is, for example, as follows: an input by the first switch (a); an input by the first switch (b); an input by the second switch (c); and an input by the second switch (d), it is determined at (b) that inputs have been continuously performed by the first switch, and then the object is caused to perform the first action. Also, it is determined at (c) that alternate inputs have been performed, and then the object is caused to perform the second action. Further, it is determined at (d) that inputs have been continuously performed by the second switch, and then the object is caused to perform the third action.

When the first determination means determines (a) that inputs by the first switch have been continuously performed, the action control means may cause the object in the virtual game world to move or accelerate in a first direction associated with the first switch, and when the first determination means determines (b) that inputs by the first switch and the at least one other switch have been alternately performed, the action control means may cause the object in the virtual game world to move or accelerate in a second direction different from the first direction.

In the case where other than inputs from the first switch and the at least one other switch, there are factors determining a moving direction of the object (e.g., a change in the moving direction caused by: influence of gravity, a contact with a ground or obstacle, and other inputs performed by the player), the first and second directions are not necessarily required to be determined taking these factors into account. A factor causing the object to move or accelerate in the first direction arises in response to the first determination means determining that inputs have been continuously performed by the first switch. Also, a factor causing the object to move or accelerate in the second direction arises in response to the first determination means determining that inputs have been performed by the first switch and the at least one other switch alternately.

Each time an input by the first switch is detected by the input detection means, the first determination means may determine, based on an input performed within a past predetermined period of time, whether inputs have been continuously performed by the first switch, or inputs have been alternately performed by the first switch and the at least one other switch.

The first determination means may determine, by referring to a series of inputs which have been continuously performed without having an interval equal to or longer than a predetermined time period, whether inputs by the first switch have been continuously performed, or inputs by the first switch and the at least one other switch have been alternately performed. To be specific, when a time interval between a timing of a most recently performed input and a timing of an input performed immediately prior to the most recently performed input is equal to or longer than the predetermined time period, the most recently performed input is recognized as a first input, and an operation for comparing the first input with an input performed immediately prior to the first input may not be performed.

The input detection means may detect, as an input performed by the input means, a change in a state of the first switch or the at least one other switch from not being pressed to being pressed by the player, or a change in a state of the first switch or the at least one other switch from being pressed by the player to not being pressed.

The first switch may be a strike surface provided on a drum controller.

The action control means may cause the object to: move or accelerate in the virtual game world in an advance direction of the object when either one of the first determination means and the second determination means determines that inputs by the first switch and the second switch have been alternately performed; move or accelerate in the virtual game world in a rightward direction with respect to the advance direction when the first determination means determines that inputs by the first switch have been continuously performed; and move or accelerate in the virtual game world in a leftward direction with respect to the advance direction when the second determination means determines that inputs by the second switch have been continuously performed.

The “advance direction” may be an anterior direction for the object (facing direction of the object), or the advance direction may be determined regardless of the facing direction of the object. In a three-dimensional virtual space in the former case, the anterior direction based on posture matrix of the object (which indicates the anterior direction, rightward direction and upward direction of the object) may be determined to be the advance direction. When the facing direction and advance direction of the object are separately controlled in the latter case, a vector indicating the advance direction (advance direction vector) or matrix indicating the advance direction (advance direction matrix) may be used in addition to the posture matrix (here, the advance direction vector only indicates the advance direction, and the advance direction matrix indicates the advance direction, a rightward direction with respect to the advance direction, and an upward direction with respect to the advance direction). The advance direction may be automatically determined based on a particular condition such as a current position of the object in the three dimensional space.

The “rightward direction with respect to the advance direction” and “leftward direction with respect to the advance direction” are preferred to be rightward and leftward directions which are symmetrical with respect to the advance direction (i.e., an angle between the advance direction and rightward direction are the same as an angle between the advance direction and leftward direction), for example, rightward and leftward directions each perpendicular to the advance direction. In the case of a three-dimensional virtual space, the “advance direction”, “rightward direction with respect to the advance direction” and “leftward direction with respect to the advance direction” are preferred to be present on a same virtual plane. However, these directions may not necessarily be on the same virtual plane if, when the “advance direction”, “rightward direction with respect to the advance direction” and “leftward direction with respect to the advance direction” are projected on a horizontal plane, or on a plane perpendicular to a normal direction from the current position of the object, or on a plane perpendicular to the upward direction of the advance direction matrix, the projected “rightward direction with respect to the advance direction” and the projected “leftward direction with respect to the advance direction” are on the right and left with respect to the projected “advance direction”. It is more preferable if these directions are symmetrical with respect to the projected “advance direction”.

The game program may further cause the computer to function as advance direction setting means for referring to, based on current position data of the object, route data defining a predetermined route in the virtual game world, thereby setting the advance direction to be consistent with the predetermined route.

The action control means may: cause the object to move or accelerate in the virtual game world in an advance direction of the object when either one of the first determination means and the second determination means determines that inputs by the first switch and the second switch have been performed alternately; change the advance direction in the virtual game world to a rightward direction when the first determination means determines that inputs by the first switch have been continuously performed; and change the advance direction in the virtual game world to a leftward direction when the second determination means determines that inputs by the second switch have been continuously performed.

The object may be a moving object moving on a racecourse set in the virtual game world. The first action may be an action to move or accelerate in the first direction perpendicular to the racecourse. The second action may be an action to move or accelerate in the second direction corresponding to a forward direction of the racecourse. The third action may be an action to move or accelerate in a third direction opposite to the first direction.

The game program may further cause the computer to function as long-pressing determination means (S40) for determining whether one or both of the first and second switches are kept pressed, and when a determination result provided by the long-pressing determination means is positive, the action control means may cause the object to decelerate.

When neither the first nor the second switch is pressed, the action control means may maintain a current moving velocity of the object.

The game program may further cause the computer to function as continuous hits speed detection means for detecting a speed of continuous hits either on the first switch or on the at least one other switch, and the action control means may cause the object to move at a speed or to accelerate at an acceleration, the speed and the acceleration each corresponding to a detection result provided by the continuous hits speed detection means.

Another computer-readable storage medium of the present invention stores a game program for controlling an action of an object in a virtual game world by using input means including a first switch (6R) and a second switch (6L) different from the first switch. The game program causes a computer (31) to function as: display control means (S10, S50), input detection means (S12), penultimate input determination means (S22), antepenultimate input determination means (S26), and action control means (S30, S32). The display control means displays the object on a screen. The input detection means detects an input performed by the input means. The penultimate input determination means determines, when the input detection means has detected an input performed by either one of the first and second switches, whether a switch most recently pressed and a switch pressed immediately prior to the most recently pressed switch are same. The antepenultimate input determination means determines, when a determination result provided by the penultimate input determination means is negative, whether the most recently pressed switch and a switch pressed two presses prior to the most recently pressed switch are same. When a determination result provided by the penultimate input determination means is positive (a), the action control means causes the object to perform an action associated with the most recently pressed switch, and when a determination result provided by the penultimate input determination means is negative and a determination result provided by the antepenultimate input determination means is positive (b), the action control means causes the object to perform a different action from the action associated with the most recently pressed switch.

When a determination result provided by the penultimate input determination means is negative and a determination result provided by the antepenultimate input determination means is also negative (c), the action control means may cause the object to perform an action associated with the most recently pressed switch.

When a determination result provided by the penultimate input determination means is negative and a determination result provided by the antepenultimate input determination means is also negative (c), the action control means may not cause the object to perform the different action.

The action control means may cause the object to perform the different action when an input by either one of the first and second switches, which has been detected by the input detection means, is an input performed for a first time (d).

Another further computer-readable storage medium of the present invention stores a game program for controlling an object moving on a racecourse set in a virtual game world by using two switches which are a first switch (6R) associated with a first direction perpendicular to the racecourse and a second switch (6L) associated with a third direction opposite to the first direction. The game program causes a computer (31) to function as display control means (S10, S50), operation detection means (S12), operation history storing means (S16), penultimate input determination means (S22), antepenultimate input determination means (S26) and action control means (S30, S32). The display control means displays the object on a screen (2). The operation detection means periodically detects, based on signals from the first and second switches, whether any of the first and second switches has been pressed. The operation history storing means temporarily stores, in a memory (32), a type of a switch which has been detected by the operation detection means as having been pressed. The penultimate input determination means determines, when the operation detection means has detected any of the first and second switches as having been pressed, whether a switch most recently pressed is the same as a switch pressed immediately prior to the most recently pressed switch. The antepenultimate input determination means determines, when a determination result provided by the penultimate input determination means is negative, whether the most recently pressed switch is the same as a switch pressed two presses prior to the most recently pressed switch. The action control means controls an action of the object such that: when a determination result provided by the penultimate input determination means is positive (a) (Yes at S22), the object moves in a direction associated with the most recently pressed switch; when a determination result provided by the penultimate input determination means is negative and a determination result provided by the antepenultimate input determination means is positive (b) (Yes at S26), the object accelerates in the third direction corresponding to a forward direction of the racecourse; and when a determination result of the penultimate input determination means is negative and a determination result provided by the antepenultimate input determination means is also negative (c) (No at S26), the object does not accelerate in the third direction.

When a determination result provided by the penultimate input determination means is negative and a determination result provided by the antepenultimate input determination means is also negative (c), the action control means may cause the object to move in a direction associated with the most recently pressed switch.

A game apparatus of the present invention comprises: input means including a first switch (6R) and at least one other switch (6L) different from the first switch; display control means (31, S10, S50) for displaying, on a screen, an object in a virtual game world; input detection means (31, S12, S60, S68) for detecting an input performed by the input means; first determination means (31, S20, S22, S24, S26, S62) for, each time the input detection means detects an input performed by the input means, determining whether inputs have been continuously performed by the first switch, or inputs have been alternately performed by the first switch and the at least one other switch; and action control means (31, S30, S32, S64, S66, S72, S74) for, when the first determination means determines (a) that inputs have been continuously performed by the first switch, causing the object to perform a first action associated with the first switch, and for, when the first determination means determines (b) that inputs by the first switch and the at least one other switch have been alternately performed, causing the object to perform a second action different from the first action.

Another game apparatus of the present invention comprises: input means including a first switch (6R) and a second switch (6L) different from the first switch; display control means (31, S10, S50) for displaying, on a screen, an object in a virtual game world; input detection means (31, S12) for detecting an input performed by the input means; penultimate input determination means (31, S22) for, when the input detection means has detected an input performed by either one of the first and second switches, determining whether a switch most recently pressed and a switch pressed immediately prior to the most recently pressed switch are same; antepenultimate input determination means (31, S26) for, when a determination result provided by the penultimate input determination means is negative, determining whether the most recently pressed switch and a switch pressed two presses prior to the most recently pressed switch are same; and action control means (31, S30, S32) for, when a determination result provided by the penultimate input determination means is positive (a), causing the object to perform an action associated with the most recently pressed switch, and for, when a determination result provided by the penultimate input determination means is negative and a determination result provided by the antepenultimate input determination means is positive (b), causing the object to perform a different action from the action associated with the most recently pressed switch.

Another further game apparatus of the present invention comprises: two switches which are a first switch (6R) associated with a first direction perpendicular to a racecourse set in a virtual game world and a second switch (6L) associated with a third direction opposite to the first direction; display control means (31, S10, S50) for displaying, on a screen, an object moving on the racecourse; operation detection means (31, S12) for periodically detecting, based on signals from the first and second switches, whether any of the first and second switches has been pressed; operation history storing means (31, S16) for temporarily storing, in a memory, a type of a switch which has been detected by the operation detection means as having been pressed; penultimate input determination means (31, S22) for determining, when the operation detection means has detected any of the switches as having been pressed, whether a switch most recently pressed is the same as a switch pressed immediately prior to the most recently pressed switch; antepenultimate input determination means (31, S26) for determining, when a determination result provided by the penultimate input determination means is negative, whether the most recently pressed switch is the same as a switch pressed two presses prior to the most recently pressed switch; and action control means (31, S30, S32) for controlling an action of the object such that: when a determination result provided by the penultimate input determination means is positive (a) (Yes at S22), the object moves in a direction associated with the most recently pressed switch; when a determination result provided by the penultimate input determination means is negative and a determination result provided by the antepenultimate input determination means is positive (b) (Yes at S26), the object accelerates in the third direction corresponding to a forward direction of the racecourse; and when a determination result of the penultimate input determination means is negative and a determination result provided by the antepenultimate input determination means is also negative (c) (No at S26), the object does not accelerate in the third direction.

Another further computer-readable storage medium of the present invention stores a game program for controlling an action of an object in a virtual game world by using input means which is capable of detecting a first operation performed by a player (an operation to press 6R, an operation to press 7R, or an operation to perform a movement input by 7R′) and a second operation performed by the player (an operation to press 6L, an operation to press 7L, or an operation to perform a movement input by 7L′) which is different from the first operation. The game program causes a computer to function as display control means (S10, S50), input detection means (S12, S60, S68), first determination means (S20, S22, S24, S26, S62) and action control means (S30, S32, S64, S66, S72, S74). The display control means displays the object on a screen (2). The input detection means detects an input performed by the input means. Each time the input detection means detects the first operation, the first determination means determines whether the first operation has been continuously performed, or the first and second operations have been alternately performed. When the first determination means determines (a) that the first operation has been continuously performed, the action control means causes the object to perform a first action associated with the first operation, and when the first determination means determines (b) that the first and second operations have been alternately performed, the action control means causes the object to perform a second action different from the first action.

The present invention makes it possible to give various action instructions to the character in the virtual game world by using continuous inputs based on a plurality of switch operations or a plurality of movement input operations.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view of a game system 1 according to an embodiment of the present invention;

FIG. 2 is an external view of the game system 1 in the case where a commonly used controller is used;

FIG. 3 is a diagram showing an internal configuration of a game apparatus body 3;

FIG. 4 shows an exemplary game image to be displayed on a screen of a television 2;

FIG. 5 shows an exemplary setting of an advance direction of a character;

FIG. 6 shows a memory map of a work memory 32;

FIG. 7 shows a part of a flowchart showing a sequence of processes performed by a CPU 31;

FIG. 8 shows a remaining part of the flowchart showing the sequence of processes performed by the CPU 31;

FIG. 9 shows a correspondence between patterns of hitting operations and actions of the character;

FIG. 10 illustrates input means of another embodiment of the present invention;

FIG. 11 shows a flowchart of said another embodiment of the present invention;

FIG. 12 shows a flowchart of another further embodiment of the present invention; and

FIG. 13 is an external view of the game system 1 in the case where a controller having a movement sensor is used.

### DESCRIPTION OF THE PREFERRED EMBODIMENTS

Hereinafter, a game system according to an embodiment of the present invention will be described with reference to the drawings.

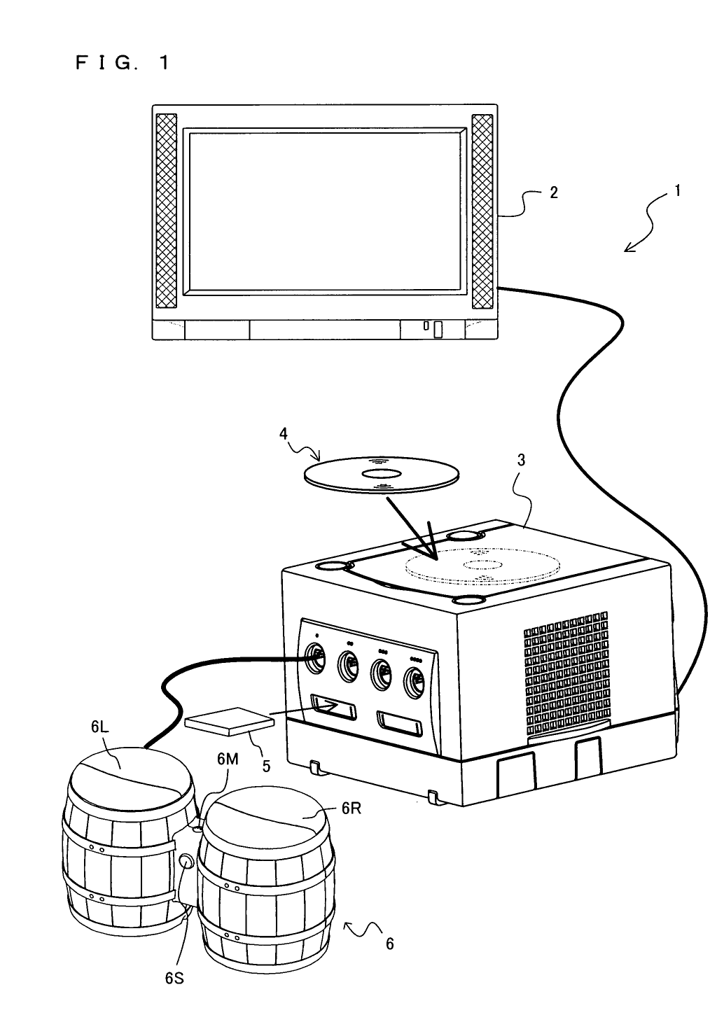

FIG. 1 is an external view showing a configuration of the game system according to the embodiment of the present invention. As shown in FIG. 1, a game system 1 comprises a television 2, game apparatus body 3, DVD-ROM 4, memory card 5 and a conga controller 6. The DVD-ROM 4 and memory card 5 are mounted on the game apparatus body 3 in a removable manner. The conga controller 6 is connected, by a communication cable, to any of four controller port connectors provided on the game apparatus body 3. The television 2 is connected to the game apparatus body 3 by an AV cable or the like. Note that, the game apparatus body 3 and controller 6 may communicate with each other by radio communication.

The conga controller 6 is provided with a microphone 6M and three switches: a start button 6S, a right strike surface 6R, and a left strike surface 6L. As described herein below, a player can control a motion of a character in a virtual game world by hitting the right strike surface 6R or left strike surface 6L.

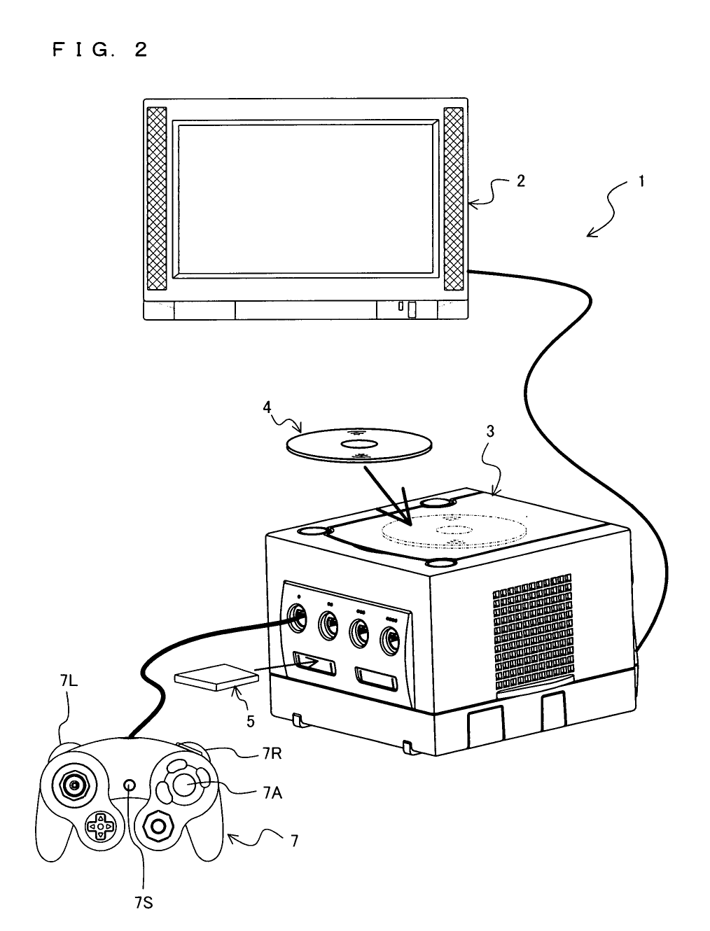

Note that, a commonly used controller 7 as shown in FIG. 2 may be used instead of the conga controller 6. The controller 7 is provided with a plurality of switches such as a start button 7S, A button 7A, R button 7R and an L button 7L. The player can use, for example, the R button 7R and L button 7L instead of the right strike surface 6R and left strike surface 6L of the conga controller 6.

The DVD-ROM 4 fixedly stores a game program, game data and the like. The DVD-ROM 4 is mounted on the game apparatus body 3 when the player plays a game. Here, instead of the DVD-ROM 4, an external storage medium such as a CD-ROM, MO, memory card, ROM cartridge or the like may be used as means for storing the game program and the like.

The game apparatus body 3 reads the game program stored in the DVD-ROM 4, and then performs processing in accordance with the read game program.

The television 2 displays, on a screen, image data outputted from the game apparatus body 3.

The memory card 5 has a rewritable storage medium, e.g., a flash memory, as a backup memory for storing data such as saved data of the game.

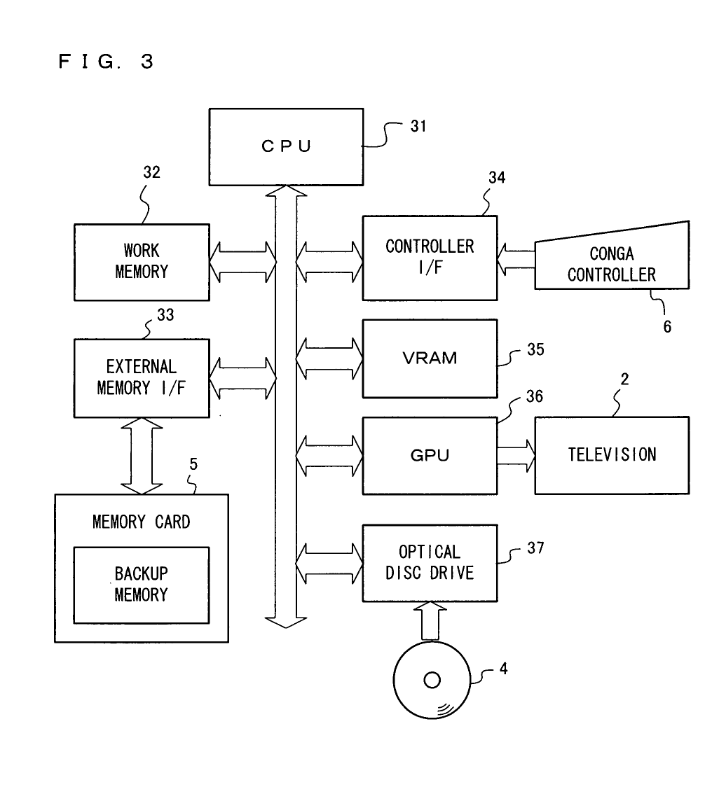

FIG. 3 is a block diagram showing an internal configuration of the game apparatus body 3. Hereinafter, each component of the game system 1 will be described in more detail with reference to FIG. 3.

As shown in FIG. 3, the game apparatus body 3 comprises a CPU 31, work memory 32, external memory interface (I/F) 33, controller interface (I/F) 34, video RAM (VRAM) 35, graphics processing unit (GPU) 36 and an optical disc drive 37.

In order for the game to start, the optical disc drive 37 drives the DVD-ROM 4 mounted on the game apparatus body 3, and then the game program stored in the DVD-ROM 4 is loaded into the work memory 32. The game starts when the CPU 31 executes the program in the work memory 32. After the game starts, the player plays the game by using the conga controller 6. In accordance with an operation performed by the player, the conga controller 6 outputs operation data to the game apparatus body 3. The operation data outputted from the conga controller 6 is supplied to the CPU 31 via the controller I/F 34. The CPU 31 performs a game process based on inputted operation data. The GPU 36 is used for image data generation and the like performed in the game process.

The GPU 36 performs, for coordinates of a solid model of an object or figure (e.g., an object comprised of polygons) placed in a three-dimensional virtual game world, arithmetic processing (e.g., rotation, scaling and deformation of the solid model, and coordinate transformation from a world coordinate system to a camera coordinate system or screen coordinate system). Further, the GPU 36 generates a game image by writing, based on a predetermined texture, color data (RGB data) of each pixel of the solid model projected on the screen coordinate system into the VRAM 35. The GPU 36 thus generates the game image to be displayed on the television 2, and outputs the game image to the television 2 as necessary. Although the present embodiment shows a hardware configuration in which a memory dedicated for image processing (VRAM 35) is separately provided, the present invention is not limited thereto. For example, a UMA (Unified Memory Architecture) system, in which a part of the work memory 32 is used as a memory for image processing, may be used.

The work memory 32 stores various programs and pieces of data loaded from the DVD-ROM 4. These pieces of data include, for example, data, which is related to polygons comprising a three-dimensional model placed in the virtual game world, and a texture used for coloring the polygons.

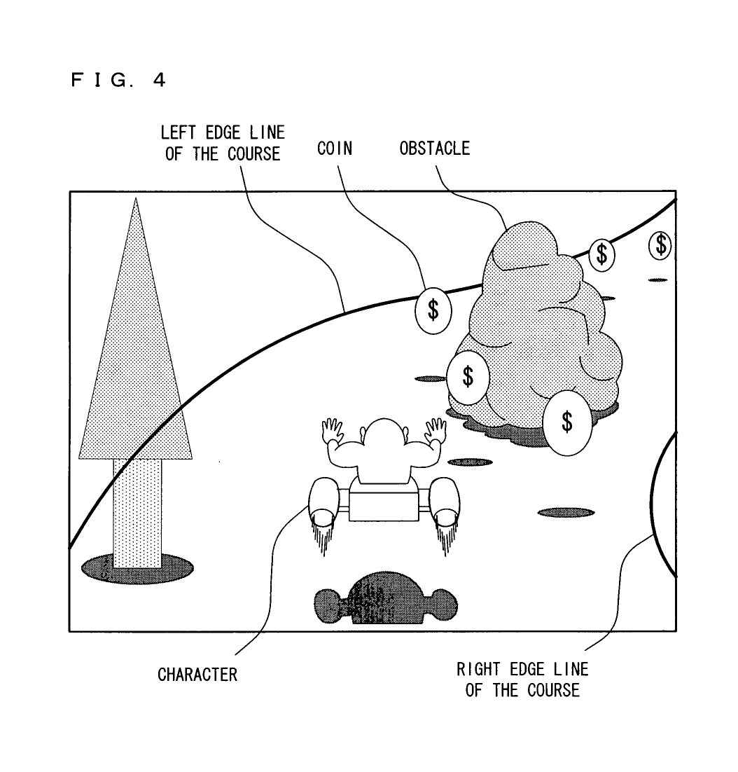

FIG. 4 is an example of the game image to be displayed on the screen of the television 2. Although the present embodiment shows an example in which the present invention is applied to a racing game, the present invention is not limited thereto. The present invention is applicable to an arbitrary game.

On the screen of the television 2, a racecourse set in a virtual game world, a player character controlled by a player, obstacles, coins and others placed on the racecourse are displayed. The player controls the player character by the conga controller 6 so that: the payer character may collide with as few obstacles as possible; the player can acquire as many coins as possible; and the player character can reach the goal as quickly as possible.

Instructions which the player is able to input by using the conga controller 6 are, for example, an acceleration instruction, rightward movement instruction, leftward movement instruction and a deceleration instruction.

The player can input the acceleration instruction by continuously and alternately hitting the right strike surface 6R and left strike surface 6L of the conga controller 6. When the acceleration instruction is inputted, the character accelerates forward (in a facing direction of the character, or in an advance direction of the character).

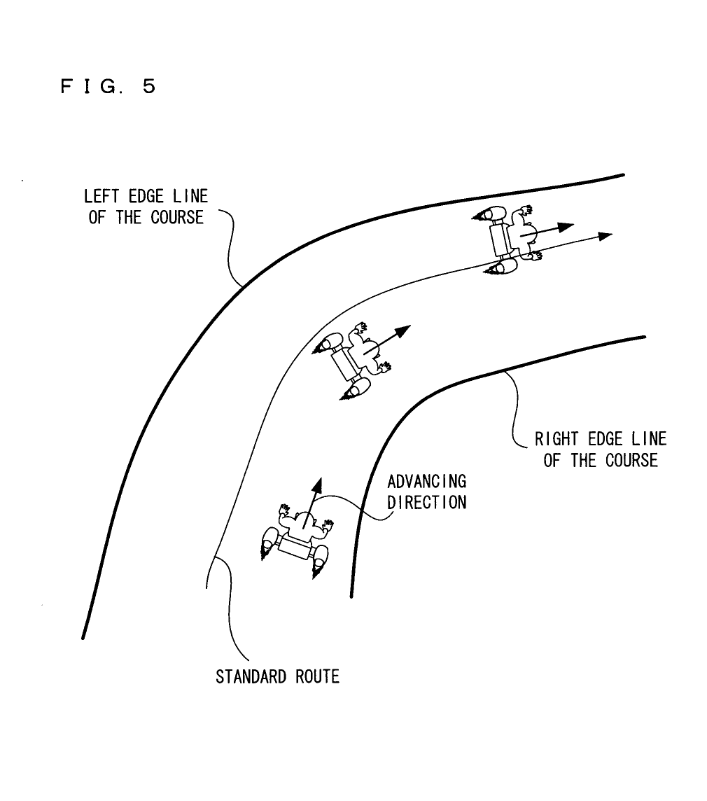

Here, the advance direction is not necessarily always the same in the virtual game world. The advance direction may be set separately for respective regions of the virtual game world. Further, as shown in FIG. 5, the advance direction may be updated whenever necessary so as to be always in parallel with a standard route set in the virtual game world. In order to realize such processing, route data defining the standard route may be prepared, for example. Then, based on the route data and a current position of the character, the CPU 31 may update the advance direction of the character whenever necessary such that the advance direction is consistent with the standard route.

The player can input the rightward movement instruction by continuously hitting the right strike surface 6R of the conga controller 6. When the rightward movement instruction is inputted, the character moves in a rightward direction (a rightward direction with respect to the facing direction of the character, or a rightward direction with respect to the advance direction of the character). The more quickly the player continuously hits the right strike surface 6R, the more quickly the character moves in the rightward direction. Here, instead of moving the character in the rightward direction, the facing direction or advance direction of the character may be changed to a rightward direction with respect to a current facing direction or current advance direction of the character.

The player can input the leftward movement instruction by continuously hitting the left strike surface 6L of the conga controller 6. When the leftward movement instruction is inputted, the character moves in a leftward direction (a leftward direction with respect to the facing direction of the character, or a leftward direction with respect to the advance direction of the character). The more quickly the player continuously hits the left strike surface 6L, the more quickly the character moves in the leftward direction. Here, instead of moving the character in the leftward direction, the facing direction or advance direction of the character may be changed to a leftward direction with respect to the current facing direction or current advance direction of the character.

The player can input the deceleration instruction by pressing both the right strike surface 6R and left strike surface 6L of the conga controller 6 for a predetermined period of time or longer. When the deceleration instruction is inputted, the character decelerates.

Hereinafter, operations of the game apparatus body 3 according to the present embodiment will be described in detail.

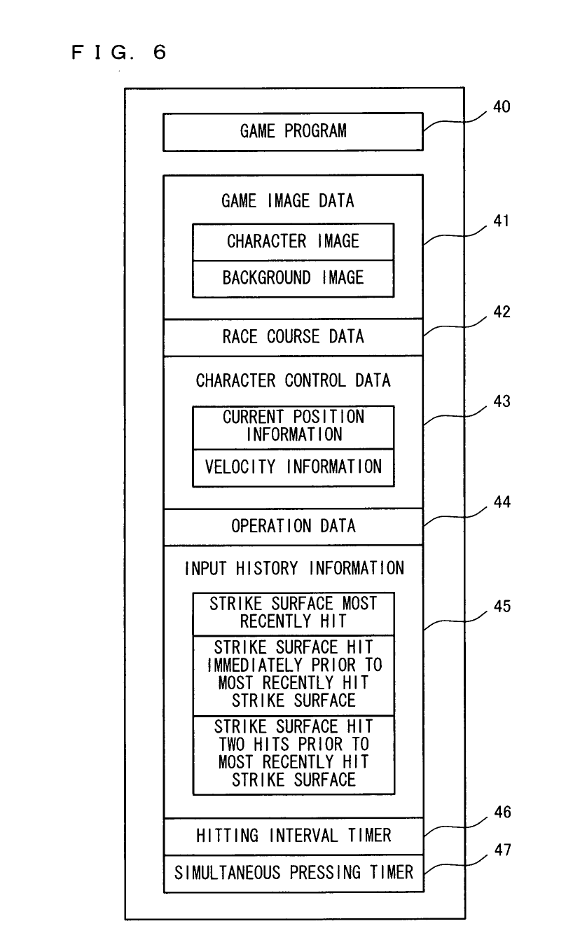

FIG. 6 is a memory map of the work memory 32. The work memory 32 stores a game program 40, game image data 41, racecourse data 42, character control data 43, operation data 44, input history information 45, hitting interval timer 46 and a simultaneous pressing timer 47.

The game image data 41 is data for generating a game image to be displayed on the screen of the television 2, and contains a character image and a background image.

The racecourse data 42 is data indicating a shape of the racecourse set in the virtual game world.

The character control data 43 is data for controlling a movement of the character in the virtual game world, and contains current position information and velocity information. The current position information indicates a current position of the character (coordinate data), and the velocity information indicates a moving velocity of the character (vector data).

The operation data 44 is data outputted from the conga controller 6. To be specific, the operation data 44 indicates, for example: whether or not the player is pressing the start button 6S; whether or not the player is pressing the right strike surface 6R; and whether or not the player is pressing the left strike surface 6L.

The input history information 45 indicates, for each of previous three times of hitting a strike surface by the player, a type of the strike surface hit by the player (i.e., the right strike surface 6R or left strike surface 6L hit by the player).

The hitting interval timer 46 is a timer for measuring a time interval between hitting operations (operations to hit the right strike surface 6R or left strike surface 6L) performed by the player.

The simultaneous pressing timer 47 is a timer for measuring a duration time during which the player performs a simultaneous pressing operation (an operation for pressing both the right strike surface 6R and left strike surface 6L for a long period of time).

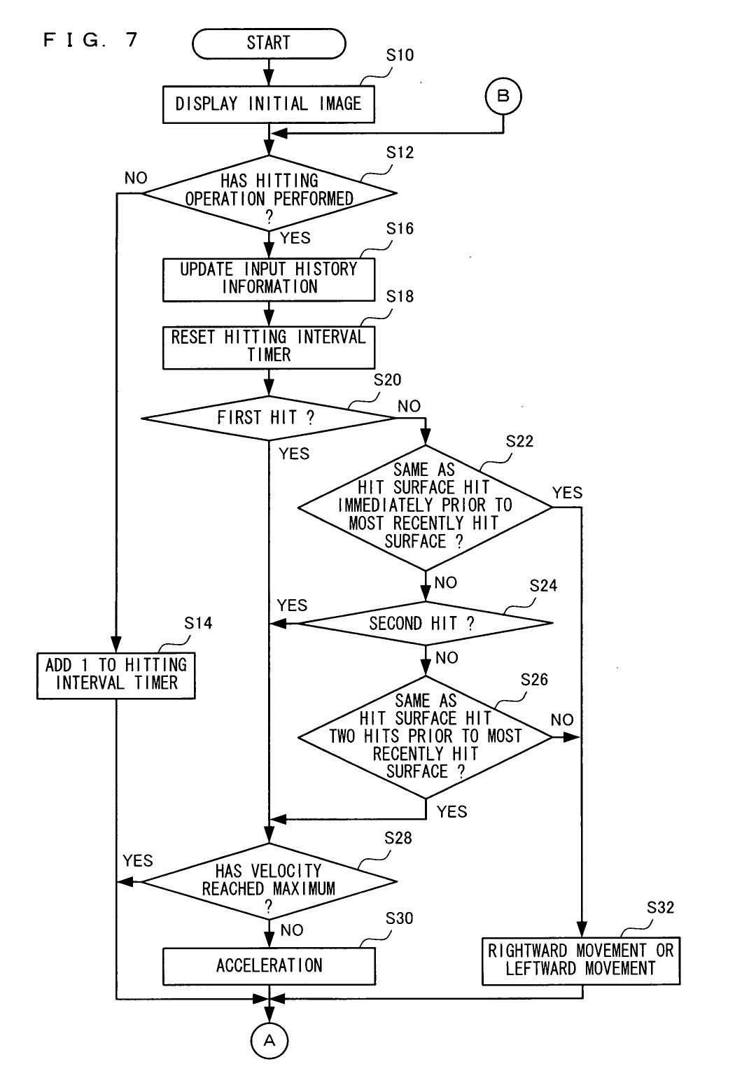

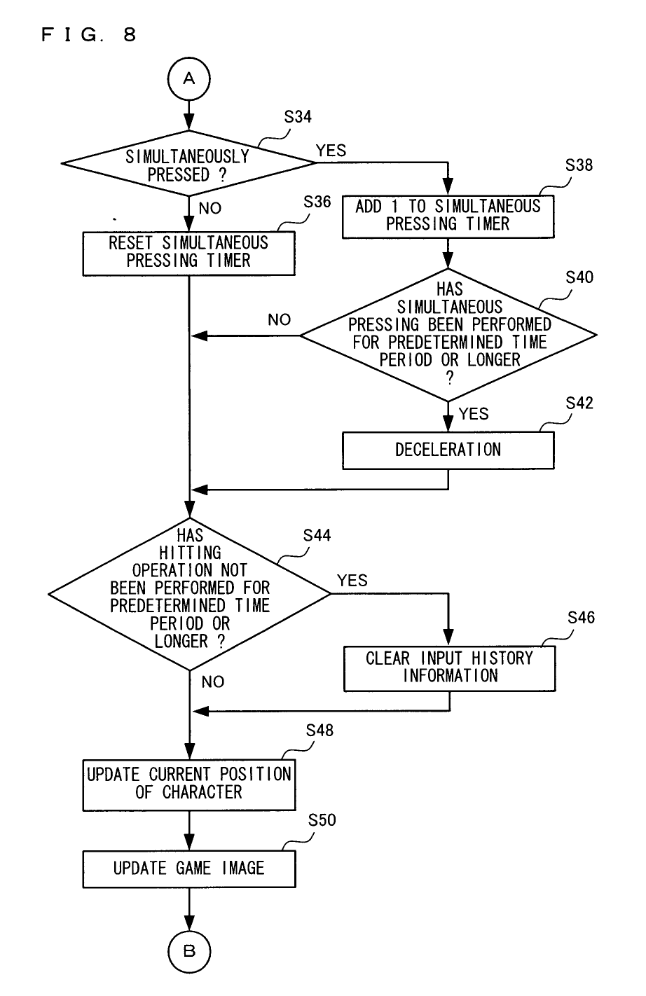

Hereinafter, a sequence of processes performed by the CPU 31 in accordance with the game program 40 will be described with reference to flowcharts of FIGS. 7 and 8.

As shown in FIG. 7, when the game program 40 starts to be executed, the CPU 31 displays an initial image at step S10. At this point, a current position and a velocity of the character are set to initial values.

It is determined, with reference to the operation data 44, at step S12 whether the player has performed a hitting operation. Here, it is determined that the player has performed a hitting operation when a state of the right strike surface 6R or left strike surface 6L has changed from being pressed by the player to not being pressed. As an exemplary variation, the determination that the player has performed a hitting operation may be provided when the state of the right strike surface 6R or left strike surface 6L has changed from not being pressed to being pressed by the player. When it is determined that the player has performed a hitting operation, processing proceeds to step S16. When it is determined that the player has not performed a hitting operation, the processing proceeds to step S14. Note that, when both the right strike surface 6R and left strike surface 6L are being pressed, it is determined that the player has not performed a hitting operation, and the processing proceeds to step S14.

At step S14, 1 is added to the hitting interval timer 46. Then, the processing proceeds to step S34 of FIG. 8.

At step S16, the input history information 45 is updated. To be specific, information, which indicates a type of strike surface (i.e., the right strike surface 6R or left strike surface 6L) which has been hit, by the player, at the hitting operation most recently detected (i.e., the hitting operation detected at step S12 immediately preceding step S16), is added to the input history information 45 as ‘strike surface most recently hit’. Here, if ‘strike surface most recently hit’ or ‘strike surface hit immediately prior to the most recently hit strike surface’ in the input history information 45 already contains a piece of information indicating a strike surface, the piece of information contained in ‘strike surface most recently hit’ is moved to ‘strike surface hit immediately prior to the most recently hit strike surface’, and the piece of information contained in ‘strike surface hit immediately prior to the most recently hit strike surface’ is moved to ‘strike surface hit two hits prior to the most recently hit strike surface’. Then, the information contained in ‘strike surface most recently hit’ is updated.

At step S18, the hitting interval timer 46 is reset to 0.

It is determined at step S20 whether the hitting operation most recently detected is a ‘first hit among a sequence of continuous hits’. To be specific, the input history information 45 is referred to first, and if information about the strike surface hit immediately prior to the most recently hit strike surface is not retained therein, the hitting operation most recently detected is determined to be a ‘first hit among a sequence of continuous hits’. In the present embodiment, the most recently performed hitting operation is determined to be a ‘first hit among a sequence of continuous hits’ when a time interval between the most recently performed hitting operation and the hitting operation immediately preceding the most recently performed hitting operation is equal to or longer than a predetermined time period (e.g., 60 frame periods). When the hitting operation most recently detected is a ‘first hit among a sequence of continuous hits’, the processing proceeds to step S28. When the hitting operation most recently detected is not a ‘first hit among a sequence of continuous hits’, the processing proceeds to step S22.

It is determined, with reference to the input history information 45, at step S22 whether the ‘strike surface most recently hit’ is the same as the ‘strike surface hit immediately prior to the most recently hit strike surface’. When the ‘strike surface most recently hit’ is the same as the ‘strike surface hit immediately prior to the most recently hit strike surface’, the processing proceeds to step S32. When the ‘strike surface most recently hit’ is not the same as the ‘strike surface hit immediately prior to the most recently hit strike surface’, the processing proceeds to step S24.

It is determined at step S24 whether the hitting operation most recently detected is a ‘second hit among a sequence of continuous hits’. To be specific, the input history information 45 is referred to first, and if information about the strike surface hit two hits prior to the most recently hit strike surface is not retained therein, the hitting operation most recently detected is determined to be a ‘second hit among a sequence of continuous hits’. In the present embodiment, the most recently performed hitting operation is determined as a ‘second hit among a sequence of continuous hits’ when a time interval between a hitting operation preceding, by two hitting operations, the most recently performed hitting operation and the hitting operation immediately preceding the most recently performed hitting operation is equal to or longer than a predetermined time period (e.g., 60 frame periods), and also a time interval between the hitting operation immediately preceding the most recently performed hitting operation and the most recently performed hitting operation is shorter than the predetermined time period. When the hitting operation most recently detected is a ‘second hit among a sequence of continuous hits’, the processing proceeds to step S28. When the hitting operation most recently detected is not a ‘second hit among a sequence of continuous hits’, the processing proceeds to step S26.

It is determined, with reference to the input history information 45, at step S26 whether the ‘strike surface most recently hit’ is the same as the ‘strike surface hit two hits prior to the most recently hit strike surface’. When the ‘strike surface most recently hit’ is the same as the ‘strike surface hit two hits prior to the most recently hit strike surface’, the processing proceeds to step S28. When the ‘strike surface most recently hit’ is not the same as the ‘strike surface hit two hits prior to the most recently hit strike surface’, the processing proceeds to step S32.

It is determined, with reference to the velocity information (velocity vector) of the character control data 43, at step S28 whether the velocity of the character (size of the velocity vector) has reached a predetermined maximum value. When the velocity of the character has reached the maximum value, the processing proceeds to step S34 of FIG. 8. When the velocity of the character has not reached the maximum value, the processing proceeds to step S30.

At step S30, the velocity information (velocity vector) of the character control data 43 is updated such that the velocity of the character (size of the velocity vector) increases by a predetermined amount. Here, instead of increasing the velocity by the predetermined amount, the amount of increase in the velocity may be varied in accordance with a current velocity, or in accordance with the shape of the racecourse. After step S30, the processing proceeds to step S34 of FIG. 8.

At step S32, the current position information of the character control data 43 is updated such that the character moves in a direction corresponding to the ‘strike surface most recently hit’. To be specific, when the strike surface most recently hit is the right strike surface 6R, the current position information is updated such that the character moves in a rightward direction. When the strike surface most recently hit is the left strike surface 6L, the current position information is updated such that the character moves in a leftward direction. Here, instead of updating the current position information, a direction of the velocity vector may be changed in accordance with the ‘most recently hit strike surface’.

It is determined at step S34 of FIG. 8 whether both the right strike surface 6R and left strike surface 6L are being pressed. When both the strike surfaces are being pressed, the processing proceeds to step S38. When only one of the strike surfaces is being pressed, or neither is being pressed, the processing proceeds to step S36.

At step S36, the simultaneous pressing timer 47 is reset to 0.

At step S38, 1 is added to the simultaneous pressing timer 47.

It is determined, with reference to the simultaneous pressing timer 47, at step S40 whether both the right and left strike surfaces have been pressed for a predetermined period of time or longer. For example, a determination that both the right and left strike surfaces have been pressed for a predetermined period of time or longer is provided when a value of the simultaneous pressing timer 47 is equal to or greater than 10. The processing proceeds to step S42 when both the right and left strike surfaces have been pressed for a predetermined period of time or longer. Otherwise, the processing proceeds to step S44.

At step S42, the velocity information (velocity vector) of the character control data 43 is updated such that the velocity of the character (size of the velocity vector) is decreased by a predetermined amount. Here, instead of decreasing the velocity by a predetermined amount, the amount of decrease in the velocity may be varied in accordance with a current velocity, or in accordance with the shape of the racecourse.

It is determined, with reference to the hitting interval timer 46, at step S44 whether a hitting operation has not been performed for a predetermined period of time or longer. For example, a determination that a hitting operation has not been performed for a predetermined period of time or longer is provided when the value of the hitting interval timer 46 is equal to or greater than 60. The processing proceeds to step S46 when a hitting operation has not been performed for a predetermined period of time or longer. Otherwise, the processing proceeds to step S48.

At step S46, the input history information 45 is cleared.

At step S48, the current position information is updated based on the velocity information.

At step S50, the game image is updated based on the updated current position information. Then, the processing returns to step S12.

The above-described processes (processes from steps S12 to S50) are reiterated at a cycle of one frame period ( 1/60 sec).

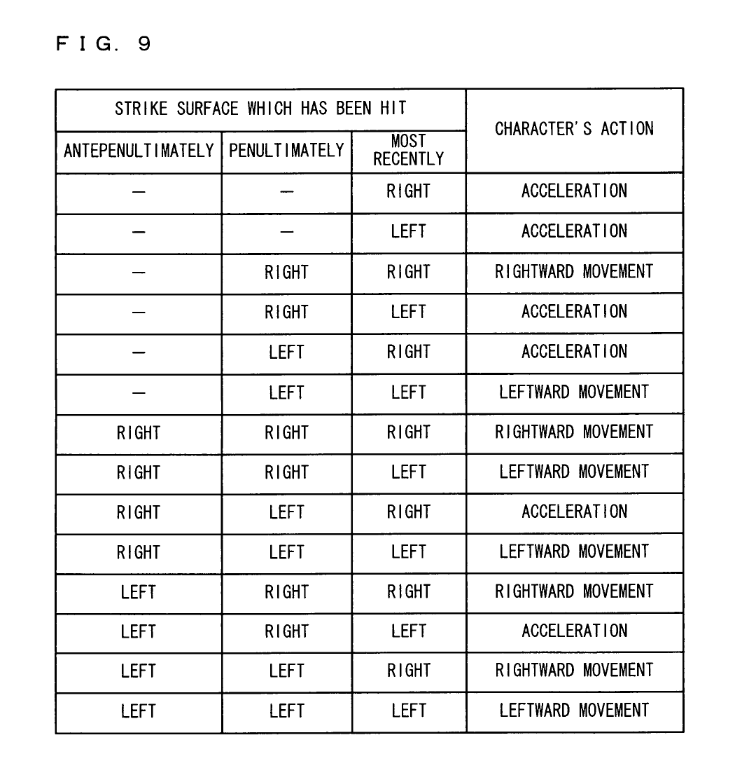

FIG. 9 shows an exemplary correspondence between patterns of inputs performed in hitting operations by the player and actions of the character.

In the present embodiment, the character is caused to accelerate (i.e., accelerate in the advance direction) when a hitting operation for a ‘first hit among a sequence of continuous hits’ is performed. However, the present invention is not limited thereto. When the hitting operation for the ‘first hit among a sequence of continuous hits’ is performed, the character may be caused to move in a direction corresponding to a strike surface hit in the hitting operation. Alternatively, when the hitting operation for the ‘first hit among a sequence of continuous hits’ is performed, the character may neither be caused to accelerate, to move in a rightward direction, nor to move in a leftward direction.

In the present embodiment, when the player performs hitting operations in the following pattern: hit the right strike surface; hit the right strike surface again; and then hit the left strike surface, the character is caused to move leftward without accelerating, because, compared with a situation where the player causes the character to accelerate immediately after causing the character to move rightward, a situation where the player causes the character to move leftward immediately after causing the character to move rightward (e.g., when the character makes S-turns, or when the player slightly moves the character back leftward after moving the character rightward too much) is more likely to occur. For the same reason, when the player performs hitting operations in the following pattern: hit the left strike surface; hit the left strike surface again; and then hit the right strike surface, the character is caused to move rightward without accelerating. This improves operability. As an exemplary variation, when the player performs hitting operations in either one of the following patterns: hit the right strike surface, hit the right strike surface again, and then hit the left strike surface; or hit the left strike surface, hit the left strike surface again, and then hit the right strike surface, the character may be caused to accelerate, or the character may neither be caused to accelerate, to move in a rightward direction, nor to move in a leftward direction.

In the present embodiment, when a strike surface is hit twice continuously, the character moves in a direction associated with the hit strike surface. In this case, the smaller the value of the hitting interval timer 46 (i.e., the more quickly the strike surface is hit), the farther (or the faster) the character may be caused to move, or the more the character may be caused to accelerate. Similarly, in the present embodiment, the character accelerates when the right strike surface 6R and left strike surface 6L are hit alternately. Here, the smaller the value of the hitting interval timer 46 (i.e., the more quickly the strike surfaces are hit), the more the character may be caused to accelerate, or the farther the character may be caused to move.

Note that, the memory map of FIG. 6 and flowcharts of FIGS. 7 and 8 are merely examples. It is understood that a memory map and flowcharts which are different from those of FIGS. 6, 7 and 8 may be used in order to obtain same processing results as those described in the present embodiment.

As described above, according to the present embodiment, the player is allowed to continuously provide at least three different action instructions to the character in the virtual game world, by merely hitting the two strike surfaces.

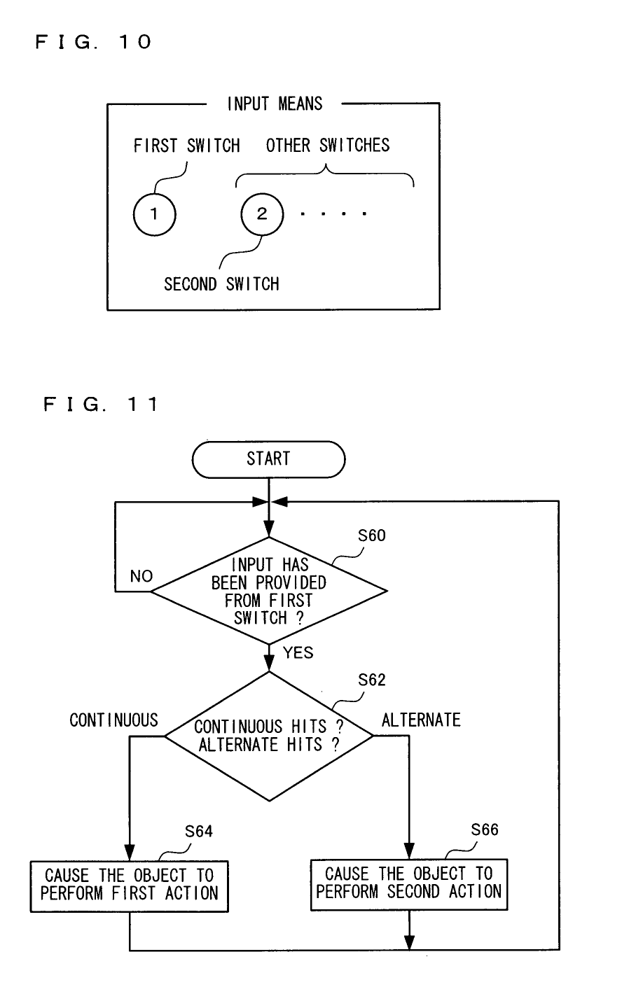

Next, another embodiment of the present invention will be described with reference to FIGS. 10 to 12.

The embodiment described below relates to a game program for controlling an action of the object in the virtual game world by using input means having a first switch and at least one other switch different from the first switch. The first switch may be, for example, the right strike surface 6R of FIG. 1 or the R button 7R of FIG. 2. The at least one other switch may be an arbitrary switch(es) different from the first switch. For example, when it is assumed in the example of FIG. 2 that the R button 7R is the first switch, the L button 7L, start button 7S and A button 7A are the other switches.

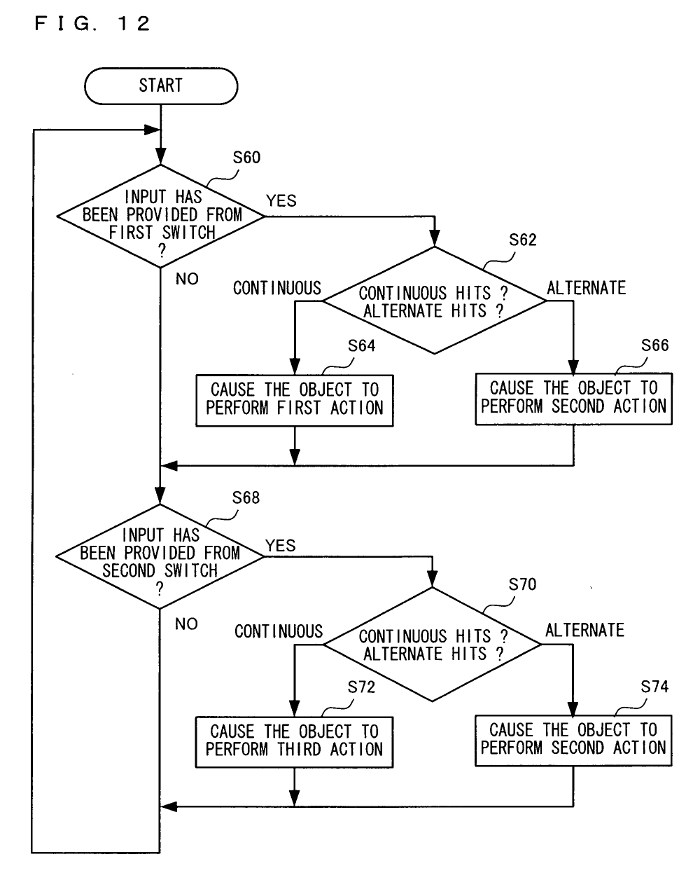

FIG. 11 is an exemplary game process performed by the CPU 31 in accordance with the game program. Hereinafter, the game process will be described in detail with reference to FIG. 11.

At step S60, the CPU 31 determines whether an input has been provided from the first switch. When an input has been provided from the first switch, the processing proceeds to step S62. When an input has not been provided from the first switch, a process at step S60 is reiterated until an input has been provided from the first switch.

When an input from the first switch is detected at step S60, the CPU 31 determines at step S62 whether inputs have been performed continuously through the first switch, or performed through the first switch and another switch alternately. This determination can be made based on a history of operations previously performed by the player. For example, if, immediately before an input from the first switch is detected at step S60, an input has been performed through the first switch, it may be determined that inputs have been continuously performed through the first switch. Also, if, immediately before an input from the first switch is detected at step S60, an input has been performed through another switch, it may be determined that inputs have been performed through the first switch and said another switch alternately.

At step S62, in the case where the input means include a plurality of other switches, an input from any of all the switches different from the first switch may be recognized as an ‘input from another switch’. Alternatively, only an input from a particular switch (e.g., second switch) may be recognized as an ‘input from another switch’. For example, if, in the case where an input from any of all the switches different from the first switch is recognized as an ‘input from another switch’, the player performs inputs in the following pattern: an input from the first switch; an input from a third switch; and an input from the first switch, it is determined that inputs have been performed through the first switch and another switch alternately. On the other hand, in the case where only an input from the second switch is recognized as an ‘input from another switch’, an input from the third switch is ignored in the determination at step S62. Therefore, it is determined that inputs have been continuously performed through the first switch.

When it is determined at step S62 that inputs have been continuously performed through the first switch, the processing proceeds to step S64, whereas when it is determined that inputs have been performed through the first switch and another switch alternately, the processing proceeds to step S66.

At step S64, the object is caused to perform a first action. At step S66, the object is caused to perform a second action which is different from the first action.

FIG. 12 shows a flowchart of another further embodiment in which each time an input from the first or second switch is detected, it is determined whether: inputs have been continuously performed through the first switch; inputs have been continuously performed through the second switch; or inputs have been performed through the first switch and the second switch alternately.

Since processes performed at steps S60 to S66 of FIG. 12 are the same as those of FIG. 11, descriptions thereof will be omitted.

At step S68 in FIG. 12, the CPU 31 determines whether an input from the second switch has been provided. When an input from the second switch has been provided, the processing proceeds to step S70. When an input from the second switch has not been provided, the processing returns to step S60.

When an input from the second switch is detected at step S68, the CPU 31 determines at step S70 whether inputs have been continuously performed through the second switch, or inputs have been performed through the second switch and the first switch alternately. When it is determined that inputs have been continuously performed through the first switch, the processing proceeds to step S72. When it is determined that inputs have been performed through the first switch and second switch alternately, the processing proceeds to step S74.

At step S72, the object is caused to perform a third action which is different from the first and second actions. At step S74, the object is caused to perform the second action.

As described above, in the present embodiment, each time an input from the first or second switch is detected, it is determined whether: inputs have been continuously performed through the first switch; inputs have been continuously performed through the second switch; or inputs have been performed through the first switch and the second switch alternately. The object can be caused to perform different actions each corresponding to a result of this determination.

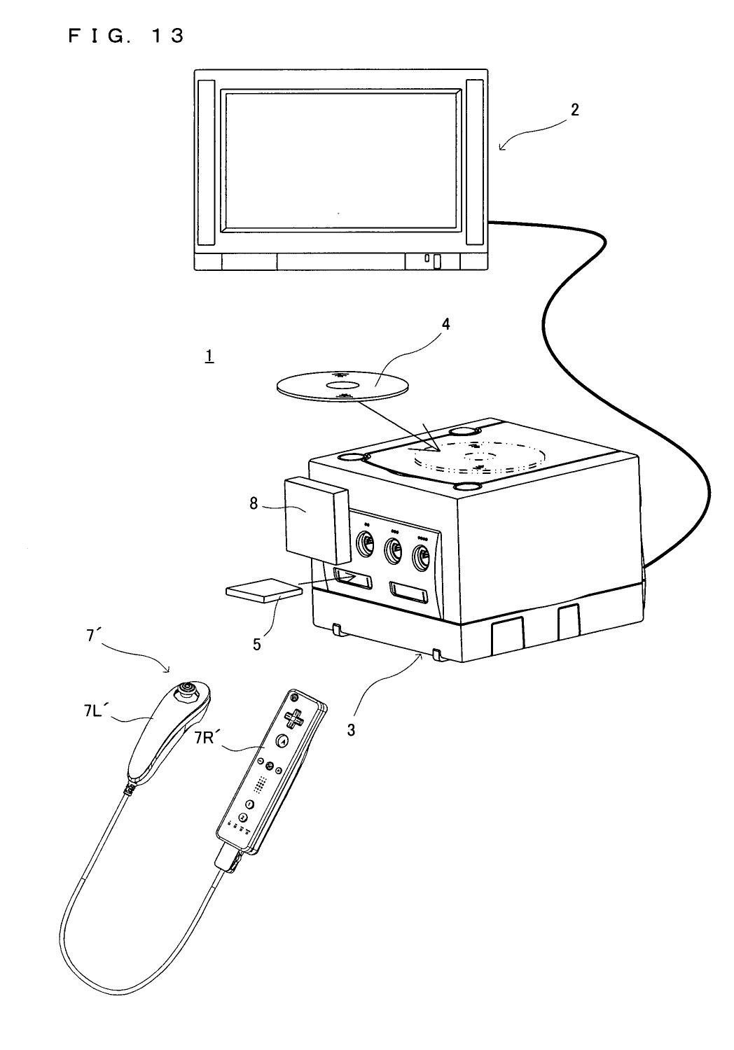

Note that, instead of the conga controller 6, a controller 7′ as shown in FIG. 13 may be used. The controller 7′ includes a core unit 7R′ and sub unit 7L’. The core unit 7R′ and sub unit 7L′ each have such a shape and size as to be held by a player with either left or right hand. The core unit 7R′ and sub unit 7L′ each have therein an acceleration sensor which is not shown. A reception unit 8 is connected via a connection terminal to the game apparatus 3. Further, at least one of the core unit 7R′ and sub unit 7L′ includes a communication section therein. The communication section transmits, to the game apparatus 3 to which the reception unit 8 is connected, an output value of each acceleration sensor. Here, both the core unit 7R′ and sub unit 7L may include the communication section, and the communication section of the core unit 7R′ may transmit, to the reception unit 8, the output value of the acceleration sensor of the core unit 7R′, and the communication section of the sub unit 7L may transmit, to the reception unit 8, the output value of the acceleration sensor of the sub unit 7L. As shown in the diagram, the core unit 7R′ and sub unit 7L′ may be connected by cable (or wirelessly connected), and the output values of the acceleration sensors may be transmitted to the reception unit 8 from a single communication section. The game apparatus 3 uses a known analysis processing to analyze the output value of each acceleration sensor, which has been received via the reception unit 8, and determines, based on the processing performed by the CPU 31, whether the core unit 7R′ and sub unit 7L′ have moved in a predetermined manner (for example, whether the units have been waved up and down). This enables a determination to be made as to, for example, whether the player has held the core unit 7R′ or sub unit 7L′ with his/her hand and waved the unit. A program for making the above determination is typically stored in an optical disc together with a game program. This program is loaded to the work memory 32, and then executed by the CPU 31. For example, when it is determined that the core unit 7R′ has moved in a predetermined manner, a process, which is performed when the right strike surface 6R of the conga controller is hit, may be performed. Also, when it is determined that the subunit 7L′ has moved in a predetermined manner, a process, which is performed when the left strike surface 6L of the conga controller is hit, may be performed. Here, a movement sensor other than the acceleration sensor may be used. In such a case, the CPU may perform a process for detecting a movement in accordance with a characteristic of the movement sensor.

While the invention has been described in detail, the foregoing description is in all aspects illustrative and not restrictive. It is understood that numerous other modifications and variations can be devised without departing from the scope of the invention.

What is claimed is:

1. A computer-readable storage medium storing a game program for controlling an action of an object in a virtual game world by using input means including a first switch and at least one other switch different from the first switch, the game program causing a computer to function as:
display control means for displaying the object on a screen;
input detection means for detecting an input performed by the input means;
first determination means for, each time the input detection means detects an input performed by the first switch, determining whether inputs have been continuously performed by the first switch, or inputs have been alternately performed by the first switch and the at least one other switch; and
action control means for, when the first determination means determines (a) that inputs have been continuously performed by the first switch, causing the object to perform a first action associated with the first switch, and for, when the first determination means determines (b) that inputs by the first switch and the at least one other switch have been alternately performed, causing the object to perform a second action different from the first action.

2. The computer-readable storage medium according to claim 1, wherein
the input means includes at least a second switch as the at least one other switch,
the first determination means determines, each time the input detection means detects an input performed by the first switch, whether inputs by the first switch have been continuously performed, or inputs by the first switch and the second switch have been alternately performed,
when the first determination means determines (a) that inputs by the first switch have been continuously performed, the action control means causes the object to perform the first action, and when the first determination means determines (b) that inputs by the first switch and the second switch have been alternately performed, the action control means causes the object to perform the second action.

3. The computer-readable storage medium according to claim 2, wherein
the game program further causes the computer to function as second determination means which determines, each time the input detection means detects an input performed by the second switch, whether inputs by the second switch have been continuously performed, or inputs by the first switch and the second switch have been alternately performed,
when the second determination means determines (c) that inputs by the second switch have been continuously performed, the action control means causes the object to perform a third action associated with the second switch, and when the second determination means determines (d) that inputs by the first switch and the second switch have been alternately performed, the action control means causes the object to perform the second action.

4. The computer-readable storage medium according to claim 1, wherein when the first determination means determines (a) that inputs by the first switch have been continuously performed, the action control means causes the object in the virtual game world to move or accelerate in a first direction associated with the first switch, and when the first determination means determines (b) that inputs by the first switch and the at least one other switch have been alternately performed, the action control means causes the object in the virtual game world to move or accelerate in a second direction different from the first direction.

5. The computer-readable storage medium according to claim 1, wherein each time an input by the first switch is detected by the input detection means, the first determination means determines, based on an input performed within a past predetermined period of time, whether inputs have been continuously performed by the first switch, or inputs have been alternately performed by the first switch and the at least one other switch.

6. The computer-readable storage medium according to claim 1, wherein the first determination means refers to a series of inputs, which have been continuously performed without having an interval equal to or longer than a predetermined time period, thereby determining whether inputs by the first switch have been continuously performed, or inputs by the first switch and the at least one other switch have been alternately performed.

7. The computer-readable storage medium according to claim 1, wherein the input detection means detects, as an input performed by the input means, a change in a state of the first switch or the at least one other switch from not being pressed to being pressed by the player, or a change in a state of the first switch or the at least one other switch from being pressed by the player to not being pressed.

8. The computer-readable storage medium according to claim 1, wherein the first switch is a strike surface provided on a drum controller.

9. The computer-readable storage medium according to claim 3, wherein the action control means causes the object to:
move or accelerate in the virtual game world in an advance direction of the object when either one of the first determination means and the second determination means determines that inputs by the first switch and the second switch have been alternately performed;
move or accelerate in the virtual game world in a rightward direction with respect to the advance direction when the first determination means determines that inputs by the first switch have been continuously performed; and
move or accelerate in the virtual game world in a leftward direction with respect to the advance direction when the second determination means determines that inputs by the second switch have been continuously performed.

10. The computer-readable storage medium according to claim 9, wherein the game program further causes the computer to function as
advance direction setting means for referring to, based on current position data of the object, route data defining a predetermined route in the virtual game world, thereby setting the advance direction to be consistent with the predetermined route.

11. The computer-readable storage medium according to claim 3, wherein the action control means:
causes the object to move or accelerate in the virtual game world in an advance direction of the object when either one of the first determination means and the second determination means determines that inputs by the first switch and the second switch have been performed alternately;
changes the advance direction in the virtual game world to a rightward direction when the first determination means determines that inputs by the first switch have been continuously performed; and
changes the advance direction in the virtual game world to a leftward direction when the second determination means determines that inputs by the second switch have been continuously performed.

12. The computer-readable storage medium according to claim 4, wherein
the object is a moving object moving on a racecourse set in the virtual game world,
the first action is an action to move or accelerate in the first direction perpendicular to the racecourse,
the second action is an action to move or accelerate in the second direction corresponding to a forward direction of the racecourse, and
the third action is an action to move or accelerate in a third direction opposite to the first direction.

13. The computer-readable storage medium according to claim 12, wherein
the game program further causes the computer to function as long-pressing determination means for determining whether one or both of the first and second switches are kept pressed, and
when a determination result provided by the long-pressing determination means is positive, the action control means decelerates the object.

14. The computer-readable storage medium according to claim 12, wherein when neither the first nor the second switch is pressed, the action control means maintains a current moving velocity of the object.

15. The computer-readable storage medium according to claim 4, wherein
the game program further causes the computer to function as continuous hits speed detection means for detecting a speed of continuous hits either on the first switch or on the at least one other switch, and
the action control means causes the object to move at a speed or to accelerate at an acceleration, the speed and the acceleration each corresponding to a detection result provided by the continuous hits speed detection means.

16. A computer-readable storage medium storing a game program for controlling an action of an object in a virtual game world by using input means including a first switch and a second switch different from the first switch, the game program causing a computer to function as:
display control means for displaying the object on a screen;
input detection means for detecting an input performed by the input means;
penultimate input determination means for, when the input detection means has detected an input performed by either one of the first and second switches, determining whether a switch most recently pressed and a switch pressed immediately prior to the most recently pressed switch are same;
antepenultimate input determination means for, when a determination result provided by the penultimate input determination means is negative, determining whether the most recently pressed switch and a switch pressed two presses prior to the most recently pressed switch are same; and
action control means for, when a determination result provided by the penultimate input determination means is positive (a), causing the object to perform an action associated with the most recently pressed switch, and for, when a determination result provided by the penultimate input determination means is negative and a determination result provided by the antepenultimate input determination means is positive (b), causing the object to perform a different action from the action associated with the most recently pressed switch.

17. The computer-readable storage medium according to claim 16, wherein the action control means causes,
when a determination result provided by the penultimate input determination means is negative and a determination result provided by the antepenultimate input determination means is also negative (c), the object to perform an action associated with the most recently pressed switch.

18. The computer-readable storage medium according to claim 16, wherein the action control means does not cause,
when a determination result provided by the penultimate input determination means is negative and a determination result provided by the antepenultimate input determination means is also negative (c), the object to perform the different action.

19. The computer-readable storage medium according to claim 16, wherein the action control means causes,
when an input by either one of the first and second switches, which has been detected by the input detection means, is an input performed for a first time (d), the object to perform the different action.

20. A game apparatus comprising:
input means including a first switch and at least one other switch different from the first switch;
display control means for displaying, on a screen, an object in a virtual game world;
input detection means for detecting an input performed by the input means;
first determination means for, each time the input detection means detects an input performed by the input means, determining whether inputs have been continuously performed by the first switch, or inputs have been alternately performed by the first switch and the at least one other switch; and
action control means for, when the first determination means determines (a) that inputs have been continuously performed by the first switch, causing the object to perform a first action associated with the first switch, and for, when the first determination means determines (b) that inputs by the first switch and the at least one other switch have been alternately performed, causing the object to perform a second action different from the first action.

21. A game apparatus comprising:
input means including a first switch and a second switch different from the first switch;
display control means for displaying, on a screen, an object in a virtual game world;
input detection means for detecting an input performed by the input means;
penultimate input determination means for, when the input detection means has detected an input performed by either one of the first and second switches, determining whether a switch most recently pressed and a switch pressed immediately prior to the most recently pressed switch are same;
antepenultimate input determination means for, when a determination result provided by the penultimate input determination means is negative, determining whether the most recently pressed switch and a switch pressed two presses prior to the most recently pressed switch are same; and
action control means for, when a determination result provided by the penultimate input determination means is positive (a), causing the object to perform an action associated with the most recently pressed switch, and for, when a determination result provided by the penultimate input determination means is negative and a determination result provided by the antepenultimate input determination means is positive (b), causing the object to perform a different action from the action associated with the most recently pressed switch.

22. A computer-readable storage medium storing a game program for controlling an action of an object in a virtual game world by using input means which is capable of detecting a first operation performed by a player and a second operation performed by the player which is different from the first operation, the game program causing a computer to function as:
display control means for displaying the object on a screen;
input detection means for detecting an input performed by the input means;
first determination means for, each time the input detection means detects the first operation, determining whether the first operation has been continuously performed, or the first and second operations have been alternately performed; and
action control means for, when the first determination means determines (a) that the first operation has been continuously performed, causing the object to perform a first action associated with the first operation, and for, when the first determination means determines (b) that the first and second operations have been alternately performed, causing the object to perform a second action different from the first action.

23. A game apparatus comprising:
input means capable of detecting a first operation and a second operation different from the first operation
display control means for displaying, on a screen, an object in a virtual game world;
input detection means for detecting an input performed by the input means;
first determination means for, each time the input detection means detects the first operation, determining whether the first operation has been continuously performed, or the first and second operations have been alternately performed; and
action control means for, when the first determination means determines (a) that the first operation has been continuously performed, causing the object to perform a first action associated with the first operation, and for, when the first determination means determines (b) that the first and second operations have been alternately performed, causing the object to perform a second action different from the first action.
